(19) United States
(12) Patent Application Publication
(10) Pub. No.: US 2008/0289571 A1
(43) Pub. Date: Nov. 27, 2008

(54) Coating apparatus

(76) Inventors: Shigemi Isobe, Shinjuku-ku (JP); Kuniaki Yamanaka, Shinjuku-ku (JP); Takashi Terada, Shinjuku-ku (JP); Yuriko Hirai, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/907,378

(22) Filed: Oct. 11, 2007

(30) Foreign Application Priority Data
Apr. 4, 2007 (JP) 2007-98151

(51) Int. Cl. A23G 3/26

(52) U.S. Cl. 118/19

(57) ABSTRACT

A hollow rotating drum 3 is rotatably arranged in an outside casing 7. On the outer circumference surface of the drum 3, along the circumferential direction thereof, there are formed ventilation sections 6 that can ventilate the inside and outside of the drum 3 in the coating processing. The ventilation sections 6 are arranged over the entire circumference of the outer circumference surface of the drum 3. In the ventilation sections 6, hollow pipes 16 through which cold air circulate are arranged with a predetermined clearance provided therebetween. Communication regions that make the inside of the drum 3 communicate with the outside thereof are formed by the clearance provided between the pipes 16. During the coating processing, arbitrarily, cold air is supplied to the pipes 16 to cool the drum 3, and the temperature difference is brought about between the inner surface of the drum 3 and products to be processed, which can prevent the coating base material from adhering to the inner surface of the drum 3.

### BACKGROUND OF THE INVENTION

1. Field of the Invention

This invention relates to a coating apparatus using a rotating container in the form of a drum, and more particularly, to a ventilation-type pan coating apparatus having the jacketless configuration used in the coating processing for tablets, foods, etc.

2. Related Art Statement

Conventionally, as a production apparatus for medical products, foods, etc., a coating apparatus using a rotating drum is known. For example, in a patent document 1, there is disclosed an apparatus provided with a rotating drum referred to as a coating pan in the form of a polygon (octagon, in this document) in cross section. FIG. 11 shows an explanatory diagram indicative of the configuration of a conventional coating apparatus 100. The coating apparatus 100 is an apparatus of the jacketless configuration, which is not provided with ventilation jackets at the outside of a rotating drum. As shown in FIG. 11, a rotating drum 101 rotates in a direction of an arrow “R” with a horizontal axis line set to the rotation center, and is housed in an outside casing 102. Powders or particles thrown into the drum 101 are rolled as the drum 101 rotates, and coating liquid is sprayed to the surface thereof from a spray device, not shown. At this time, in the drum 101, hot air or cold air is arbitrarily supplied from and exhausted to supply and exhaust ducts 103, 104, which brings forward forming and drying a coating layer.

In the coating apparatus 100, during the coating processing, hot air or cold air is arbitrarily supplied to products to be processed from the duct 103 for example. On a main trunk 105 of the drum 101, over all the eight surfaces thereof, a ventilation section 106 configured by a porous plate (punching) is formed respectively, and air which passes through layers of products to be processed is sent to the duct 104 from the ventilation sections 106. Accordingly, air supplied from the duct 103 to the inside of the drum 101 passes through layers of products to be processed, and is exhausted to the duct 104 arranged at the outer circumference of the drum 101 through the ventilation sections 106. In this way, in the coating apparatus 100, due to drying air which is supplied from and exhausted to the ducts 103, 104, the coating base material is evaporated to dryness on the surface of products to be processed, forming coating layers.

However, in the coating apparatus, since drying air which passes through layers of products to be processed is exhausted through the ventilation sections 106, the temperature of the drum 101 is increased (or decreased) during the coating processing, which makes the temperature of products to be processed substantially equal with that of the ventilation sections 106. Accordingly, there is raised a problem that the coating base material is solidified to be attached to the inner surface of the drum 101. For example, in case of the glycocalyx coating, since the drum 101 is heated by drying air, the base material (saccharose) of glycocalyx liquid is easily solidified to be attached to the inner surface of the drum 101, especially to the ventilation sections 106. In case of the chocolate coating processing, since cold air is supplied from the duct 103, similar to the former case, the temperature of products to be processed comes to be substantially equal with that of the ventilation sections 106, which raises a problem that chocolate is easily solidified to be attached to the inner surface of the drum 101.

When the solidified material adheres to the inner surface of the drum during the coating processing, in case the material is peeled off to be attached to products, there are produced defective products having raised dot or protrusions. Accordingly, in the actual coating processing, the rotating drum is suspended when the amount of the material attached to the inner surface of the drum etc. is increased, and the attached material is removed to the outside of the drum. That is, according to the conventional apparatus, so as to prevent defective products from being produced, the inside of the rotating drum has to be arbitrarily cleaned during the processing operation. Accordingly, there is raised a problem that the production efficiency is lowered and the processing operation time period is prolonged, and furthermore, at the time of the cleaning, the cleaning time period is made long since the amount of the attached material is large.

### SUMMARY OF THE INVENTION

In view of the above-identified circumstances, it is therefore an object of the present invention to provide a coating apparatus of the jacketless configuration, in which the coating base material is prevented from adhering to the inner surface of a rotating drum, especially, a rotating drum which has its entire outer circumference surface set to ventilation sections.

According to the present invention, there is provided a coating apparatus including: a hollow processing container that is rotatably arranged with a rotation axis set to the rotation center; and ventilation sections that are arranged on the outer circumference surface of the processing container along the circumferential direction thereof, and can ventilate the inside and outside of the processing container in the coating processing; wherein the ventilation sections have hollow temperature-adjusting pipes through which a temperature-adjusting medium can circulate, and communication regions which are provided between the temperature-adjusting pipes and make the inside of the processing container communicate with the outside thereof.

According to the present invention, since the ventilation sections are arranged on the outer circumference surface of the processing container of the coating apparatus, and in the ventilation sections, the temperature-adjusting pipes through which a temperature-adjusting medium can circulate are arranged with a clearance provided therebetween, and the communication regions that make the inside of the processing container communicate with the outside thereof are formed by the clearance provided between the temperature-adjusting pipes, in the coating processing, when a temperature-adjusting medium circulates through the temperature-adjusting pipes, the ventilation is performed, and concurrently the temperature adjustment for the processing container, especially for the ventilation sections is performed. In this way, during the coating processing, the temperature of the processing container is arbitrarily adjusted, and the temperature difference is brought about between the inner surface of the processing container and products to be processed, which can prevent the coating base material from adhering to the inner surface of the processing container, especially to the ventilation sections.

In the coating apparatus, the temperature-adjusting pipes may be arranged over the entire circumference of the outer circumference surface of the processing container. Furthermore, the coating apparatus may be of the jacketless configuration that is not provided with jackets which are connected to supply and exhaust paths, and are so arranged as to enclose the processing container at the outside of the processing container. Moreover, the coating apparatus may make processing gas pass through the communication regions, and concurrently make cooling medium or heating medium circulate through the temperature-adjusting pipes, and perform the coating processing with respect to products to be processed in the processing container.

### BRIEF DESCRIPTION OF THE DRAWINGS

FIG. 1 shows an explanatory diagram indicative of the configuration of a coating apparatus of the first embodiment according to the present invention, which is viewed from the side direction;

FIG. 2 shows an explanatory diagram indicative of the configuration of the coating apparatus shown in FIG. 1, which is viewed from the rear direction;

FIG. 3 shows a sectional view indicative of the configuration of a rotary joint;

FIG. 4 shows an explanatory diagram indicative of the connection configuration of the rotary joint and a drive shaft;

FIG. 5 shows a perspective view indicative of the configuration of a rotating drum;

FIG. 6 shows an explanatory diagram indicative of the configuration of a ventilation section;

FIG. 7 shows a sectional view of a principal part indicative of the configuration of a coating apparatus of the second embodiment according to the present invention;

FIG. 8 shows a perspective view indicative of the configuration of a panel unit used in the coating apparatus shown in FIG. 7;

FIG. 9 shows a variation of the configuration in which the present invention is applied to the coating apparatus of the jacketless configuration;

FIG. 10 shows an explanatory diagram indicative of the configuration in which, in a coating apparatus provided with jackets, respective surfaces of a main trunk of a rotating drum are formed by hollow pipes; and

FIG. 11 shows an explanatory diagram indicative of the configuration of a conventional coating apparatus.

### DETAILED DESCRIPTION OF THE PREFERRED EMBODIMENTS

Hereinafter, the embodiments of the present invention will be described in greater detail by referring to the accompanying drawings.

### First Embodiment

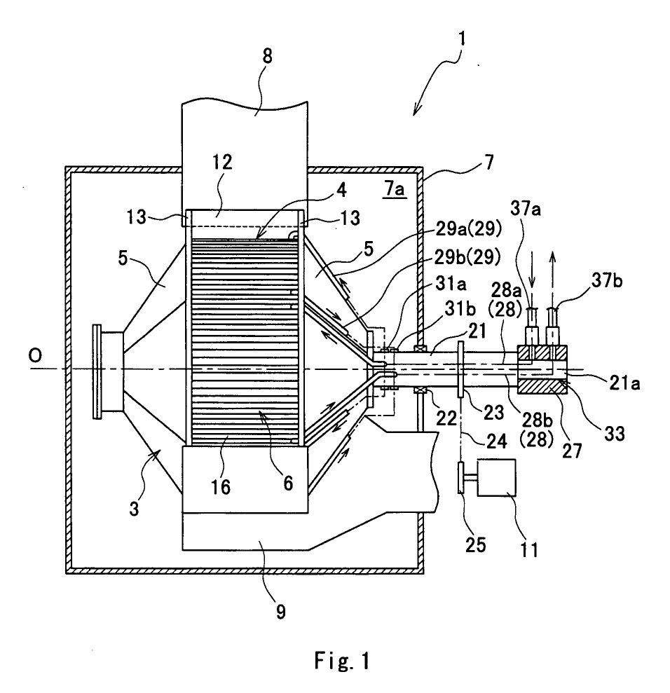

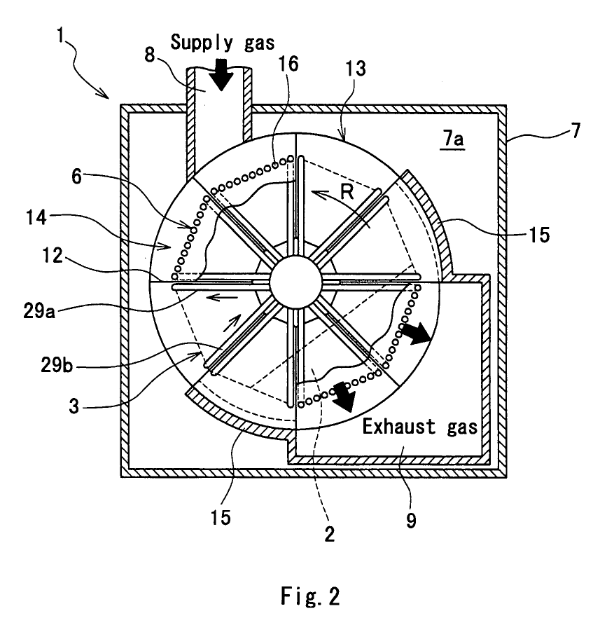

FIG. 1 shows an explanatory diagram indicative of the configuration of a coating apparatus 1 of the first embodiment according to the present invention, which is viewed from the side direction. FIG. 2 shows an explanatory diagram indicative of the configuration of the coating apparatus 1 shown in FIG. 1, which is viewed from the rear direction. The coating apparatus 1 shown in FIG. 1 is an apparatus generally referred to as a pan coating apparatus, and, utilizing the rotation of a rotating drum and using the processing gas passing through the rotating drum and coating base material, performs desired processing, or granulation, coating, drying, mixing, etc. with respect to products to be processed. In this embodiment, as the coating apparatus 1, there is employed an apparatus which performs the coating processing with respect to products to be processed 2 such as tablets and sweets using glycocalyx liquid etc. which is configured mainly by syrup obtained by dissolving saccharose in water, thereby explaining the configuration of the present invention.

The coating apparatus 1 has arranged therein a rotating drum (coating pan) 3 being a processing container in the form of a horizontal drum that contains the products to be processed 2. The rotating drum 3 includes a hollow main trunk 4 in the form of a cylinder whose cross section is polygonal or circular, and end wall sections 5 which are arranged at both ends of the main trunk 4 along the axis direction thereof. The drum 3 is rotatably arranged with a horizontal axis line “O” set to the rotation center. On the entire circumference of the main trunk 4, there are formed ventilation sections 6 through which the processing gas such as hot air or cold air circulate. In the coating apparatus 1 shown in FIG. 1, the main trunk 4 is in the form of an octagon in cross section, and the ventilation section 6 is formed on all the eight surfaces of the main trunk 4.

The drum 3 is housed in an outside casing 7. The outside casing 7 is a sealed outer frame in the form of a box, which is provided with a gas supply section 8 and a gas exhaust section 9 which make the inside of the casing 7 communicate with the outside thereof. The drum 3 is rotatably arranged in the casing 7, and is driven to be rotated in a direction of an arrow “R” shown in FIG. 2 by a motor 11. In the drum 3, a spray device, not shown, is arranged, which spray device supplies coating agent, binder liquid, etc. to the products to be processed 2 in the drum 3.

On the outer circumference of the drum 3, there are arranged partition plates 12 that sectionalize the respective sides of the octagon. The respective partition plates 12 are arranged at the respective tops of the octagon being the outer circumference of the drum 3, and are so arranged as to protrude in the radial direction respectively in a radial pattern. At both ends of the partition plates 12 along the axis direction, a sliding frame 13 in the form of a ring is arranged respectively. The sliding frames 13 face each other with the main trunk 4 sandwiched therebetween, and are arranged at the outer circumference of the drum 3, forming flanges. Accordingly, one ventilation space 14 is formed by one side of the outer circumference surface of the drum 3, partition plates 12, and sliding frames 13.

Processing gas is supplied to the ventilation spaces 14 from the gas supply section 8 arranged at the upper left of the casing 7 shown in FIG. 2 to be sent to the inside of the drum 3. Furthermore, gas in the drum 3 is exhausted to the outside of the apparatus from the gas exhaust section 9 arranged at the lower right of the casing 7 shown in FIG. 2 through the ventilation spaces 14. To the gas exhaust section 9, so as to prevent gas in a space 7a of the casing 7 from leaking, and exhaust gas effectively, a seal plate 15 is attached. The seal plate 15 is made of rubber, synthetic resin, etc., and is so arranged as to be slidably in contact with the outer circumference of the sliding frames 13 and cover the outside of the drum 3. The seal plate 15 prevents gas in the space 7a from flowing into the inside of the drum 3, and leaking from the gas exhaust section 9 through the drum 3 without contributing to drying products to be processed etc.

To the right end of the drum 3 shown in FIG. 1, a drive shaft 21 is attached. The shaft 21 is rotatably supported by a bearing 22. To the shaft 21, a sprocket 23 is attached, which is connected to a sprocket 25 through a chain 24. The sprocket 25 is driven by the motor 11, and, by actuating the motor 11, the shaft 21 is driven to be rotated, which makes the drum 3 rotate with the horizontal axis line “O” being the rotation center. To the end of the shaft 21, a rotary joint 27 is attached, which is connected to a supply and exhaust system including a pump, a heat exchanger, etc., not shown, for cooling and heating medium which is arranged at the outside of the apparatus.

In the coating apparatus 1, as shown in FIGS. 1 and 2, to the ventilation sections 6, cold air (cooling medium) as a temperature-adjusting medium can be supplied trough the rotary joint 27, a circulation opening 28, and supply and exhaust tubes 29. As the cooling medium, cold water can also be used. The circulation opening 28 is composed of a supply opening 28a and an exhaust opening 28b which are formed in the shaft 21 respectively. In the shaft 21, connection ports 31a, 31b for the supply opening 28a and exhaust opening 28b are arranged, and to the respective connection ports 31a, 31b, the supply and exhaust tubes 29 (supply tubes 29a and exhaust tubes 29b) made of synthetic resin are attached. The shaft 21 has formed therein openings 32a, 32b for the supply opening 28a and exhaust opening 28b, and is connected to the rotary joint 27.

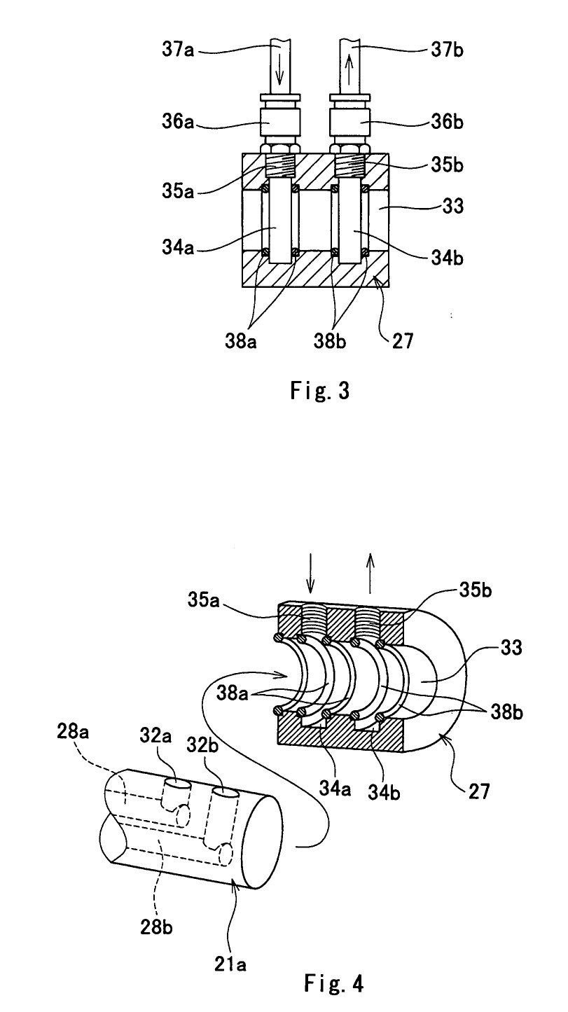

FIG. 3 shows a sectional view indicative of the configuration of the rotary joint 27, while FIG. 4 shows an explanatory diagram indicative of the connection configuration of the rotary joint 27 and shaft 21. As shown in FIGS. 3 and 4, there is formed an attachment opening 33 at the center of the rotary joint 27, and into the attachment opening 33, one end of the shaft 21 is rotatably inserted. At the peripheral wall of the attachment opening 33, two circumferential grooves 34a, 34b in the form of a concave respectively are formed. The circumferential grooves 34a, 34b are formed over the entire circumference of the peripheral wall of the attachment opening 33. To the front and rear parts of the circumferential grooves 34a, 34b, packings 38a, 38b are attached so as to prevent cold water from leaking from the circumferential grooves 34a, 34b. At the upper part of the rotary joint 27, as shown in FIGS. 3 and 4, two connection openings 35a, 35b are formed. The connection openings 35a, 35b communicate with the circumferential grooves 34a, 34b respectively in the rotary joint 27. At the inner circumference of the connection openings 35a, 35b, an internal thread is formed respectively. To the connection openings 35a, 35b, pipe sleeves 36a, 36b are attached respectively. To the pipe sleeves 36a, 36b, connection tubes 37a, 37b are attached respectively, which are connected to the above-described supply and exhaust system for cooling and heating medium.

With respect to the rotary joint 27, at one end 21a of the shaft 21, corresponding to the circumferential grooves 34a, 34b, openings 32a, 32b are formed. That is, in the rotary joint 27, when the shaft 21 is inserted to the rotary joint 27, the opening 32a faces and communicates with the circumferential groove 34a, while the opening 32b faces and communicates with the circumferential groove 34b. When the shaft 21 rotates, while the openings 32a, 32b are made to shift in the circumferential direction accordingly, the openings 32a, 32b face the circumferential grooves 34a, 34b consistently while the shaft 21 rotates. Accordingly, the supply opening 28a and exhaust opening 28b are consistently kept in the state of communicating with the connection tubes 37a, 37b, which makes it possible to consistently supply and exhaust a temperature-adjusting medium while the drum 3 is actuated.

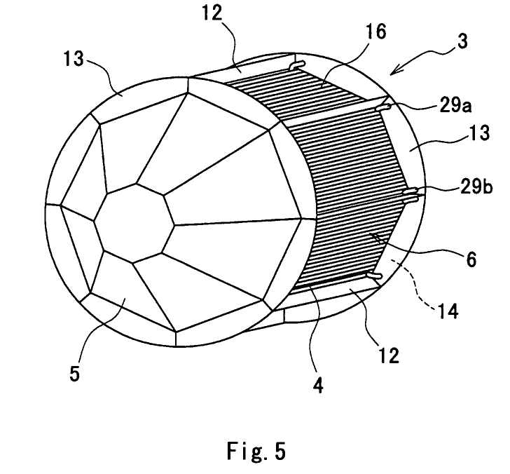

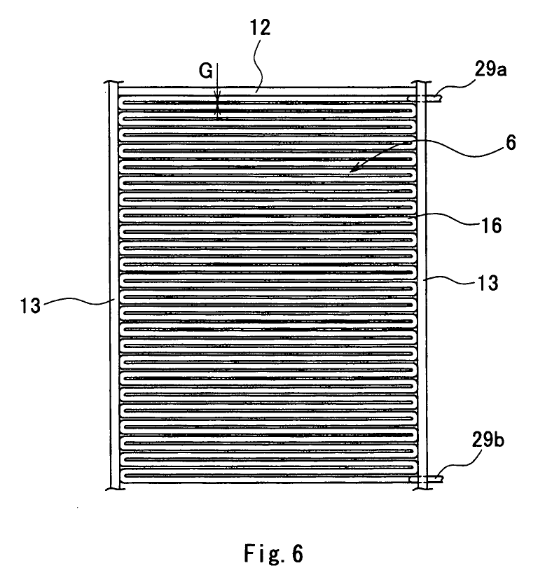

The tubes 29 attached to the connection ports 31a, 31b of the shaft 21 are connected to hollow pipes (temperature-adjusting pipes) 16 attached to the ventilation sections 6 of the drum 3. FIG. 5 shows a perspective view indicative of the configuration of the drum 3, while FIG. 6 shows an explanatory diagram indicative of the configuration of the ventilation section 6. As shown in FIG. 5, on the main trunk 4 of the drum 3, the hollow pipes 16 are arranged over the entire circumference thereof. Each of the pipes 16 is formed by a hollow round bar made of stainless (for example, Ø6, wall thickness of 1 mm). The right and left folded parts of the pipe 16 shown in FIG. 6 are fixed to the sliding frames 13 by welding. As shown in FIG. 6, the pipe 16 is configured by setting a single pipe in switchback form, and has its parts other than the folded parts set substantially parallel with each other. Between the pipes 16, a clearance (communication region) “G” of a predetermined size (for example, 2 mm) is provided. Due to the pipe 16, at the respective sides of the main trunk 4, there is formed the ventilation section 6 that makes the inside of the drum 3 communicate with the outside thereof. In the coating apparatus 1, the main trunk 4 has its each surface configured by only the pipe 16, and all the eight surfaces thereof are configured by the ventilation sections 6.

To both ends of the pipe 16, the supply tube 29a and exhaust tube 29b, which are so arranged as to penetrate the sliding frame 13, are connected. Cold air supplied to the pipe 16 from the supply tube 29a passes through the pipe 16 in the form of a sheep casing, and is exhausted from the exhaust tube 29b. In this way, when the cold air is supplied to the pipe 16, the ventilation section 6 itself is directly cooled, which can prevent the ventilation section 6 from being heated by processing gas during the coating processing. In the ventilation section 6, the pipe 16 is so arranged as to be exposed to the inside of the drum 3, and furthermore, processing gas can pass through the ventilation section 6 due to the clearance “G”. Accordingly, the coating apparatus 1 can assure the air permeability between the inside and the outside of the drum 3 due to the ventilation sections 6, and can prevent the temperature of the drum 3 from being raised due to its self cooling function.

Next, the coating processing in the coating apparatus 1 will be explained by taking the production of glycocalyx tablets for example. In this processing, firstly, tablets such as lactose tablets (for example, diameter of 8 mm, 200 mg/T) as the products to be processed 2 are thrown into the drum 3, and the motor 11 is driven to rotate the drum 3 (for example, approximately 8 rpm). As the drum 3 is rotated, the tablets are uplifted in the rotational direction along the main trunk 4 and the end wall sections 5 to be dropped to the inside thereof, that is, the tablets are rolled in the drum 3. To the products to be processed 2, while the drum 3 is rotated, glycocalyx liquid (for example, in case the processing amount of the glycocalyx tablets is approximately 100 L, 60° C., 340 to 900 ml/time) is sprayed from the spray device. At this time, hot air is arbitrarily sent from the gas supply section 8 (for example, 70° C., 12 m³/min) to solidify and form a glycocalyx coated layer on the tablets. Hot air supplied from the gas supply section 8 passes through the inside of the drum 3 to be exhausted to the outside of the apparatus from the gas exhaust section 9.

On the other hand, in the coating apparatus 1, during the coating processing, cold air is arbitrarily supplied to the pipes 16 to cool the ventilation sections 6. To and from the pipes 16, cold air is supplied and exhausted through the rotary joint 27, circulation opening 28, and supply and exhaust tubes 29. That is, cold air supplied from the supply and exhaust system for cooling and heating medium is sent through a path of the connection tube 37a→pipe sleeve 36a→connection opening 35a→circumferential groove 34a to the opening 32a, and is sent to the supply tubes 29a through the supply opening 28a and the connection port 31a, and then flows into the pipes 16. On the other hand, the cold air which is heated by the pipes 16 to be exhausted is sent to the connection port 31b through the exhaust tubes 29b, and is sent through a path of the connection port 31b→exhaust opening 28b→opening 32b, and is sent to the inside of the rotary joint 27, and is then sent through a path of the circumferential groove 34b→connection opening 35b→pipe sleeve 36b connection tube 37b, and is returned to the supply and exhaust system for cooling and heating medium.

In this way, in the coating apparatus 1, since the pipes 16 are arranged in the ventilation sections 6 with a constant clearance provided therebetween, when the ventilation is performed, concurrently the ventilation sections 6 formed on the main trunk 4 can be directly cooled. Accordingly, during the coating processing, the temperature of the drum 3 can be kept low, and the temperature difference can be brought about between the inner surface of the drum 3 and the products to be processed 2, which can prevent glycocalyx liquid from adhering to the inner surface of the drum 3, especially to the ventilation sections 6 to which the base material is easily attached. Accordingly, occurrence of raised dot or protrusions due to the peel-off of the attached material can be prevented, and the attached material can be significantly reduced as compared with the conventional apparatus using the punching in the ventilation sections, which makes it possible to reduce the rate of occurrence of defective products.

Furthermore, since the amount of the attached material on the inner surface of the drum 3 is small, the number of times of cleaning, cleaning man-hours, cleaning time period, etc. for the drum 3 can be reduced. Accordingly, the coating processing can be performed effectively, which can reduce the processing operation time period. Moreover, in the coating apparatus 1, by controlling the temperature and amount of cold air to be supplied to the ventilation sections 6, the temperature of the ventilation sections 6 can be arbitrarily adjusted. Accordingly, the optimum drum temperature can be kept according to processing conditions, which can make it possible to realize more effective coating processing.

### Second Embodiment

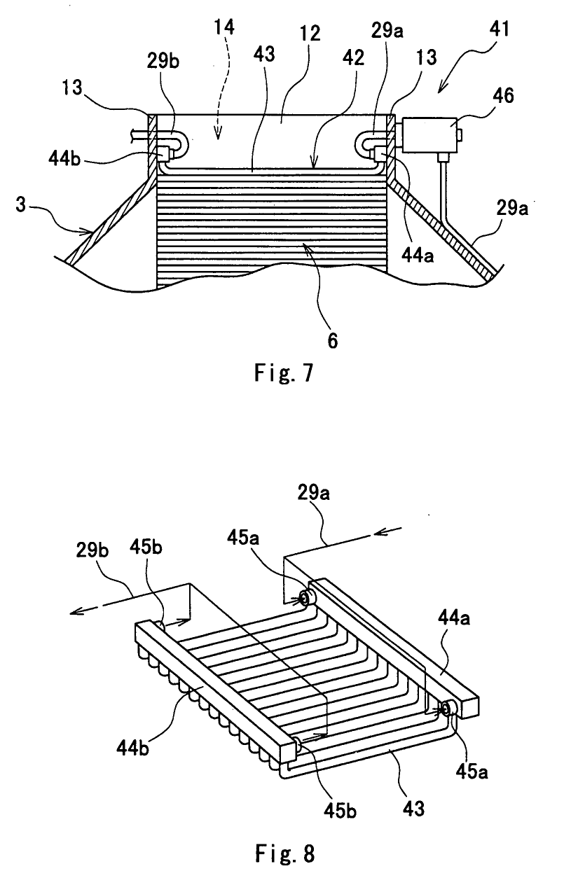

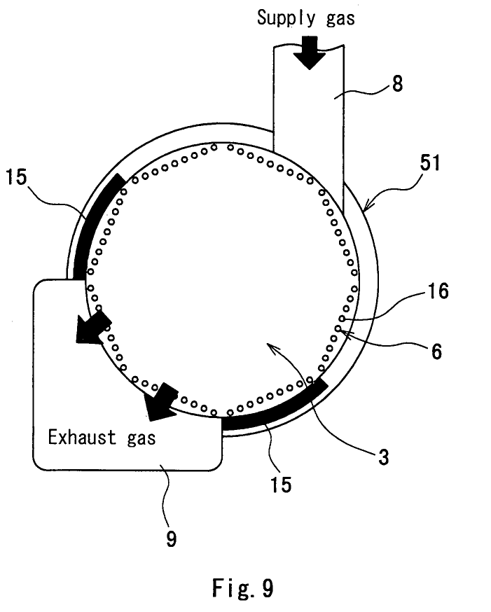

Next, a coating apparatus of the second embodiment according to the present invention will be explained. In the first embodiment, a configuration in which the pipes 16 in the form of a sheep casing respectively are arranged in the ventilation sections 6 is shown. On the other hand, there may be employed a configuration in which a unit that has a plurality of pipes 16 arranged therein in parallel is formed, and thus formed unit is attached to the main trunk 4. FIG. 7 shows a sectional view of a principal part indicative of the configuration of a coating apparatus 41 of the second embodiment. FIG. 8 shows a perspective view indicative of the configuration of a panel unit 42 used in the coating apparatus 41 shown in FIG. 7. In the following embodiment, parts or components similar to those of the first embodiment are indicated with the same reference numerals, and detailed explanation of which will be omitted.

In the panel unit 42, a plurality of hollow pipes (temperature-adjusting pipes) 43 similar to the pipe 16 in the first embodiment are arranged in parallel, and between the neighboring hollow pipes 43, a clearance (communication region) “G” of a predetermined size is provided. To both ends of the pipes 43, supply and exhaust aggregation pipes 44a, 44b formed by a hollow square bar made of stainless (for example, one side of 25 mm) respectively are fixed by welding. To the pipe 44a, two supply ports 45a are fixed by welding, while to the pipe 44b, two exhaust ports 45b are fixed by welding. In the coating apparatus 41 of the second embodiment, the supply tube 29a is connected to the supply ports 45a, while the exhaust tube 29b is connected to the exhaust ports 45b, respectively, and, during the coating processing, consistently or arbitrarily, a temperature-adjusting medium (in this embodiment, cold air) is supplied to the pipes 43. As shown in FIG. 7, to the supply tube 29a, a cooling device 46 is attached so that cold air of low temperature can be effectively supplied to the panel unit 42.

Also in the coating apparatus 41, during the coating processing, cold air is arbitrarily supplied to the pipes 43 to cool the ventilation sections 6. In this way, when the ventilation is performed, concurrently the ventilation sections 6 formed on the main trunk 4 can be directly cooled. Accordingly, during the coating processing, the temperature of the drum 3 can be kept low, which can prevent glycocalyx liquid from adhering to the inner surface of the drum 3, especially to the ventilation sections 6 to which the base material is easily attached.

The present invention is not limited to the embodiments, but various modifications can be implemented without departing from the scope and spirit of the present invention.

For example, in above-described embodiments, by taking the glycocalyx coating processing for example, the processing of supplying cold air (or cold water) to the hollow pipes 16, 43 is explained. On the other hand, the pattern of the coating processing is not restricted to the glycocalyx coating processing, and various processing patterns can be employed. For example, the present invention can be applied to the chocolate coating processing etc., in which case, as a temperature-adjusting medium, heated liquid (heating medium) such as hot air or hot water is supplied to the pipes 16, 43.

That is, in case of the chocolate coating, the pipes 16, 43 are used as heating means, and the inner surface of the drum 3, especially the ventilation sections 6 are directly heated. In this way, during the coating processing, the temperature difference can be brought about between the inner surface of the drum 3 and the products to be processed 2, which can prevent chocolate from adhering to the inner surface of the drum 3 (especially to the ventilation sections 6). Accordingly, occurrence of defective products due to the peel-off of the attached material can be prevented. Furthermore, the number of times of cleaning, cleaning man-hours, cleaning time period, etc. for the drum 3 can be reduced. Accordingly, the coating processing can be performed effectively, which can reduce the processing operation time period. Furthermore, the present invention can be applied to the processing for fat and fatty oil such as the fat and fatty oil coating (wax) processing etc., and can be employed for the purpose of sustained release of the fat and fatty oil coating processing.

The various sizes, number of the pipes 16, 43, arrangement directions (not only horizontal axis direction but also rotation direction of drum), materials of the respective members, processing conditions or temperatures, time periods, amounts, etc. in the above-described embodiments are only examples, to which values the present invention is not limited. Furthermore, the shape of the cross section of the drum 3 is not restricted to a polygon, and the present invention can be applied to a coating apparatus using a rotating drum whose cross section is circular. In case the shape of the cross section of the drum 3 is set to a circle, the pipes 16, 43 are so arranged as to extend in the horizontal axis direction of the drum 3.

In addition, in the above-described embodiments, a coating apparatus of the horizontal rotating drum type in which the drum 3 rotates with the horizontal axis line being the rotation center is explained. On the other hand, the coating apparatus is not restricted to the above-described configuration, and may be of a type provided with an inclined rotating drum whose rotation axis line is inclined with respect to the installation surface. Furthermore, products to be processed are not restricted to tablets such as the above-described lactose tablets etc, and the present invention can be applied to foods such as sweets, gums, etc. or other medical products. As for glycocalyx liquid, instead of syrup which is obtained by dissolving saccharose in water, glycocalyx liquid of various specifications can be employed such as glycocalyx liquid which is obtained by adding various medicinal effect components, flavor, dye, etc. thereto.

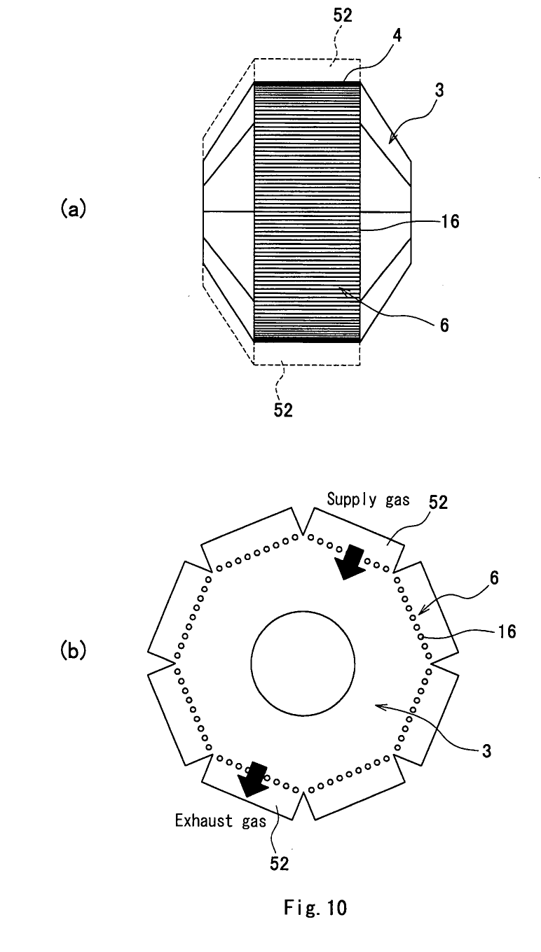

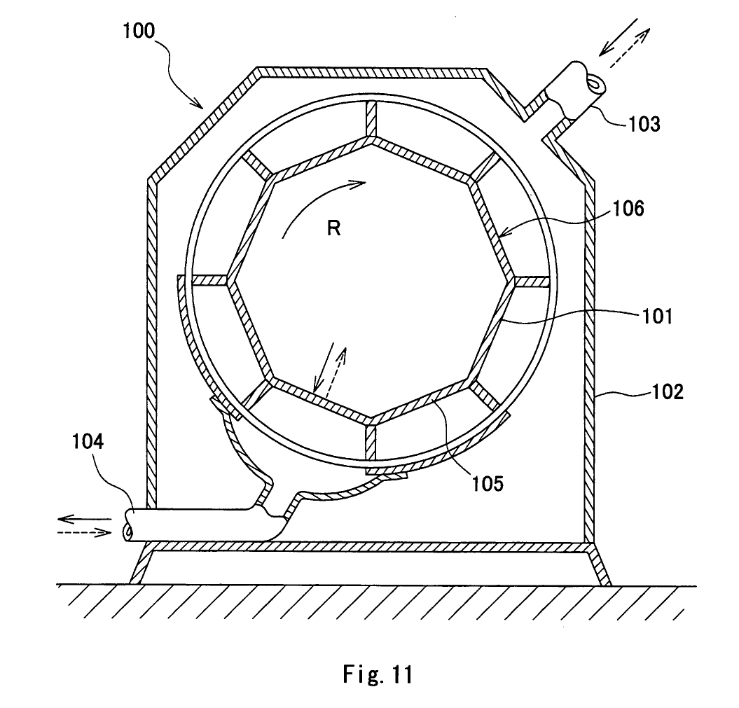

Furthermore, in the first embodiment, the drum 3 is housed in the casing 7 in the form of a box. On the other hand, as shown in FIG. 9, as an outside casing, a casing whose cross section is circular (outside casing 51), similar to the shape of the cross section of the drum 3, may be employed. Moreover, in the above-described embodiments, the present invention is applied to a coating apparatus of the jacketless configuration. On the other hand, as shown in FIG. 10, the present invention can be applied to a coating apparatus provided with jackets, in which jackets 52 are arranged at the outside of the drum 3.

What is claimed is:

1. A coating apparatus comprising:
a hollow processing container that is rotatably arranged with a rotation axis set to the rotation center; and
ventilation sections that are arranged on the outer circumference surface of the processing container along the circumferential direction thereof, and can ventilate the inside and outside of the processing container in the coating processing;
wherein the ventilation sections have hollow temperature-adjusting pipes through which a temperature-adjusting medium can circulate, and communication regions which are provided between the temperature-adjusting pipes and make the inside of the processing container communicate with the outside thereof.

2. The coating apparatus according to claim 1, wherein the temperature-adjusting pipes are arranged over the entire circumference of the outer circumference surface of the processing container.

3. The coating apparatus according to claim 1, wherein the coating apparatus is of the jacketless configuration that is not provided with jackets which are connected to supply and exhaust paths, and are so arranged as to enclose the processing container at the outside of the processing container.

4. The coating apparatus according to claim 1, wherein the coating apparatus makes processing gas pass through the communication regions, and concurrently makes cooling medium or heating medium circulate through the temperature-adjusting pipes, and performs the coating processing with respect to products to be processed in the processing container.
